(19) United States
(12) Patent Application Publication
(10) Pub. No.: US 2026/0024329 A1
(43) Pub. Date: Jan. 22, 2026

(54) PARSING HIERARCHICAL RELATIONSHIP OF ELEMENTS IN AN IMAGE

(71) Applicant: Microsoft Technology Licensing, LLC, Redmond, WA (US)

(72) Inventors: Wenxuan XIE, Beijing (CN); Xiaoyi ZHANG, Beijing (CN); Zhizheng ZHANG, Beijing (CN); Yuwang WANG, Beijing (CN); Yan LU, Beijing (CN)

(73) Assignee: Microsoft Technology Licensing, LLC, Redmond, WA (US)

(21) Appl. No.: 18/995,296

(22) PCT Filed: Aug. 20, 2023
(86) PCT No.: PCT/US2023/030651

§ 371 Date: Jan. 16, 2025

(30) Foreign Application Priority Data
Sep. 13, 2022 (CN) 202211110494.X

(51) Int. Cl. G06V 10/86; G06V 10/44; G06V 10/764; G06V 10/774; G06V 10/776

(52) U.S. Cl. CPC G06V 10/86; G06V 10/44; G06V 10/764; G06V 10/776; G06V 10/774

(57) ABSTRACT

According to the implementation of the present disclosure, a solution for parsing the hierarchical relationship of elements in an image is provided. According to the solution, the second element in the first element is determined based on a feature(s) of the input image and the first element in the input image. The third element in the second element is detected based on the feature and the second element. The first element, the second element and the third element correspond to corresponding regions in the input image. Based on the determination of the second element and the detection result of the third element, a hierarchy indicating the relationship between elements in the input image is determined. In this way, the hierarchy of elements in the image can be obtained without post-processing.

### BACKGROUND

Images can be seen everywhere in daily life. Different elements in an image usually have hierarchical relationships. Understanding of the hierarchical relationship among these elements is beneficial to some technical applications related to images. For example, intelligent devices have become an indispensable part of daily life. Through the user interface (UI) of these devices, people can interact with the device. Hierarchical relationships between UI elements in UI images (such as screenshots of web pages and mobile applications) can reveal how the UI is organized. Understanding of the hierarchical relationship between UI elements is also beneficial to reverse software engineering, UI design, human-computer interaction design, automatic testing and other technical applications.

### SUMMARY

According to implementations of the present disclosure, there is provided a solution for parsing the hierarchical relationship of elements in an image. In this solution, based on a feature(s) of an input image and a first element in the input image, a second element in the first element is determined. A third element in the second element is detected based on the feature of the input image and the second element. The first, second and the third elements are corresponding to respective regions in the input image. Based on the determination of the second element and the detection result of the third element, the hierarchy of the input image is generated. This hierarchy indicates the relationship among the elements in the input image. In this solution, elements at the next level are recursively detected from the identified elements. In this way, the hierarchical relationship of elements in the image can be determined without post-processing. In addition, this solution has wide applicability and can be used to parse various types of images.

This Summary is provided to introduce the selection of objects in a simplified form, which will be further described in the specific implementations below. This part is not intended to identify the key features or main features of the subject matter to be protected, nor to limit the scope of the subject matter to be protected.

### BRIEF DESCRIPTION OF DRAWINGS

FIG. 1 shows a block diagram of an example environment in which a plurality of implementations of the present disclosure can be implemented;

FIG. 2A shows an example of an input image and hierarchy according to some implementations of the present disclosure;

FIG. 2B shows another example of an input image and hierarchy according to some implementations of the present disclosure;

FIG. 3 shows an example architecture of an image parsing model implemented in accordance with some of the present disclosure;

FIG. 4A shows a schematic diagram of the first subtask that recursively determines the hierarchy according to some implementations of the present disclosure;

FIG. 4B shows a schematic diagram of a second subtask that recursively determines the hierarchy according to some implementations of the present disclosure;

FIG. 4C shows a schematic diagram of a third subtask that recursively determines the hierarchy according to some implementations of the present disclosure;

FIG. 4D shows a schematic diagram of a fourth subtask that recursively determines the hierarchy according to some implementations of the present disclosure;

FIG. 4E shows a schematic diagram of a fifth subtask that recursively determines the hierarchy according to some implementations of the present disclosure;

FIG. 5A shows a schematic diagram of an attention mask between different elements according to some implementations of the present disclosure;

FIG. 5B shows the dependency relationship between the output token and the input token in the parsing process according to some implementations of the present disclosure;

FIG. 6 shows a flowchart of a process for parsing hierarchical relationships of image elements implemented in accordance with some of the present disclosure; and

FIG. 7 shows a schematic block diagram of an electronic device that can implement various implementations of the present disclosure.

### DETAILED DESCRIPTIONS

Implementations of the present disclosure will now be discussed with reference to a number of example implementations. It is to be understood that these implementations are discussed only to enable those skilled in the art to better understand and thus implement the disclosure, rather than imply any limitation on the scope of the disclosure.

As used herein, the term “comprises” and its variants are to be interpreted as an open term meaning “comprises but is not limited to”. The term “based on” is to be read as “based at least in part on”. The terms “an implementation” and “one implementation” should be interpreted as “at least one implementation”. The term “another implementation” should be interpreted as “at least one further implementation”. The terms “first”, “second”, and the like may refer to different or identical objects. Other explicit and implicit definitions may also be comprised below.

As used herein, the term “element” refers to a component at any granularity in an image. Elements can comprise atomic components that can no longer be divided, or a collection of atomic components. An element corresponds to an area in the image. In particular, elements in an image may comprise the entire image or the image with non-substantial parts (e.g., a blank near the edge) removed. In this context, elements in the image can also be referred to as “image elements”.

As used herein, the term “model” can learn the association between corresponding inputs and outputs from training data, so that corresponding outputs can be generated for a given input after training. The model generation can be based on machine learning technology. Deep learning (DL) is a machine learning algorithm that processes inputs and provides corresponding outputs by using multi-layer processing units. The neural network model is an example of a model based on deep learning. In this paper, “model” can also be called “machine learning model”, “learning model”, “machine learning network” or “learning network”, and these terms are used interchangeably in this paper.

Generally, machine learning can comprise three stages, namely, training stage, testing stage and inference stage (also known as reasoning stage). In the training stage, the given model can be trained with a large number of training data, and iterate continuously until the model can obtain consistent reasoning that meets the expected goal from the training data. Through training, the model can be considered to be able to learn the association between input and output from training data (also known as input to output mapping). The parameter values of the trained model are determined. In the testing stage, a testing input is applied to the trained model to test whether the model can provide correct output, so as to determine the performance of the model. In the inference stage, the model can be used to process the actual input and determine the corresponding output based on the parameter values obtained from the training.

### Example Environment

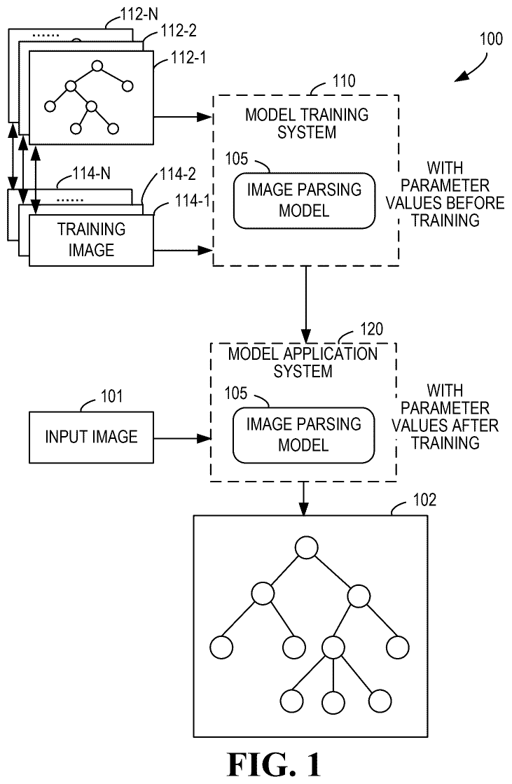

FIG. 1 shows a schematic diagram of an example environment 100 in which an implementation of the present disclosure can be implemented. In the environment 100, it is expected to train and use such an image parsing model to parse the hierarchical relationship of image elements.

As shown in FIG. 1, the environment 100 comprises a model training system 110 and a model application system 120. In the example implementation of FIG. 1, the model training system 110 is used to train the image parsing model 105 using training data. The training data can comprise multiple training images 114-1, 114-2, . . . , 114-N and the hierarchies 112-1, 112-2, . . . 112-N of corresponding image elements, where N is an integer greater than or equal to 1. For the sake of discussion, the training images are collectively or individually referred to as the training images 114, and the hierarchy is referred to as the hierarchy 112. The type of the training image 114 may be related to the scene to which the image parsing model 105 is to be applied or the type of the input image 101 to which the image parsing model 105 is to be applied, as will be described below.

Prior to training, the parameter values of the image parsing model 105 can be initialized or obtained through the pre training process. After the training process, the parameter values of the image parsing model 105 are updated and adjusted. After training, the image parsing model 105 has the parameter values after training. Based on such parameter values, the image parsing model 105 can at least parse the hierarchical relationship of image elements.

In FIG. 1, the model application system 120 receives an input image 101, which is also referred to as an image to be parsed. The model application system 120 is used to parse the hierarchical relationship of the elements in the input image 101 using the trained image parsing model 105 to obtain the hierarchy 102 for the input image 101. The hierarchy 102 (also known as the predicted hierarchy) indicates the relationship between the elements in the input image 101. A node in the hierarchy 102 corresponds to an element detected in the input image 101. For example, the root node corresponds to the entire input image 101, the leaf node corresponds to an atomic element, and the intermediate node corresponds to a collection of multiple atomic elements. Each node can store information of the corresponding element, such as the token of the element and the identification of the node. The token of the element can indicate the position of the detected element in the input image 101, the category of the element, and the like, as will be described below.

The input image 101 may be an image of any type, and the scope of the present disclosure is not limited in this regard. In some implementations, the input image 101 may comprise an image whose content is organized to a certain extent, which is also referred to as an “organized image”. Organized images can include, but are not limited to, document images, UI images, etc. For UI images such as web pages or application screenshots, image elements can comprise UI elements of various granularity. In this implementation, the training image 114 is also an image whose content is organized to a certain extent. For example, the training image 114 and the input image 101 may both be UI images.

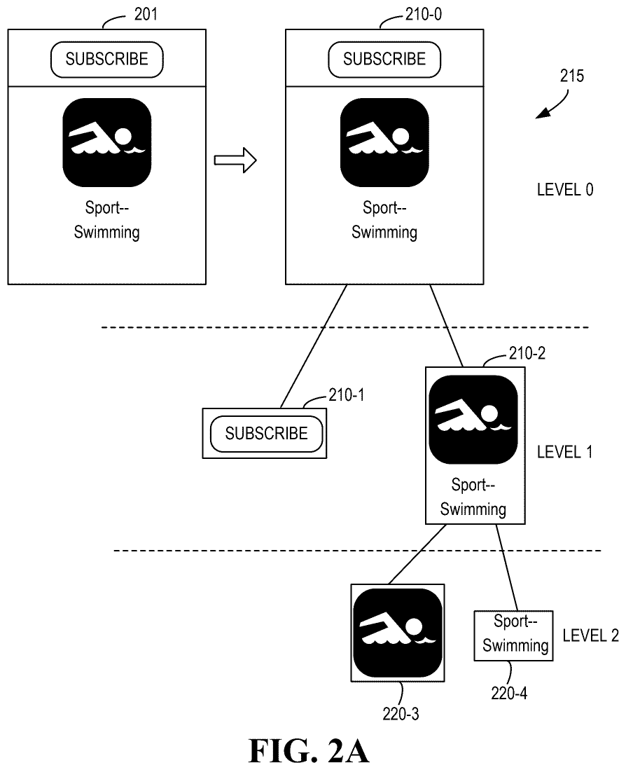

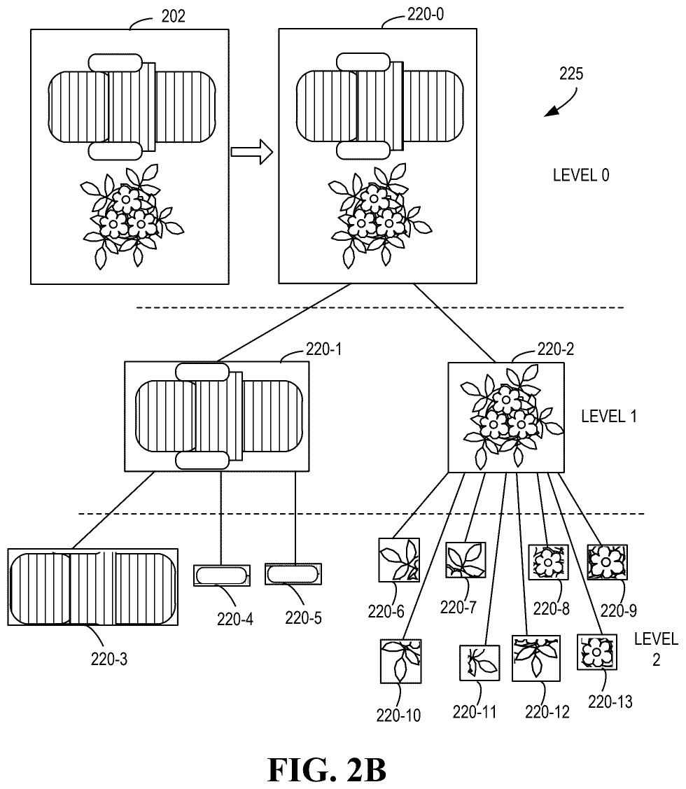

The input image 201 and the hierarchy 215 shown in FIG. 2A are examples of the input image 101 and the hierarchy 102, respectively. In this implementation, the input image 201 is a UI image. The hierarchy 215 comprises three levels, namely, level 0, level 1 and level 2. The root node in level 0 corresponds to element 210-0, which is the entire input image 201. Element 210-1 (which is a subscription option) and element 210-2 (which is the main part) in level 1 are child nodes of element 210-1. Since the main part comprises icons and text, elements 210-3 (which are icons) and 210-4 (which are text) in level 2 are child nodes of element 210-2.

In some implementations, the input image 101 may comprise a natural image whose content is not intentionally organized, such as an image of a physical environment captured by a camera. In this implementation, the training image 114 is the same type as the input image, that is, the training image 114 is also a natural image.

The input image 202 and the hierarchy 225 shown in FIG. 2B are examples of the input image 101 and the hierarchy 102, respectively. In this case, the input image 202 is a natural image, which comprises a lounge chair and plants. Hierarchy 225 comprises 3 levels, namely, level 0, level 1 and level 2. The root node in level 0 corresponds to element 220-0, which is the entire input image 202. Since the input image 202 generally comprises a lounge chair and a plant, the elements 220-1 (which is a lounge chair) and 220-2 (which is a plant) in level 1 are child nodes of element 220-0. The lounge chair also comprises a main body, an upper arm rest and a lower arm rest of the lounge chair. Therefore, element 220-3 (which is the main body of the lounge chair), element 220-4 (which is the upper arm of the lounge chair) and element 220-5 (which is the lower arm of the lounge chair) in level 2 are child nodes of element 220-1. Plants include flowers and leaves. Therefore, element 220-6 (which is a leaf), element 220-7 (which is a leaf), element 220-8 (which is a flower), element 220-9 (which is a flower), element 220-10 (which is a leaf), element 220-11 (which is a leaf), element 220-12 (which is a leaf) and element 220-13 (which is a flower) in level 2 are sub nodes of element 220-2.

It is to be understood that the input images and corresponding hierarchies in FIGS. 2A and 2B are only example and are not intended to limit the scope of the present disclosure. In the implementation of the present disclosure, the input image 101 may be any type of image. The hierarchy 102 may comprise any number of layers. And each layer can comprise any number of nodes.

Still in reference to FIG. 1, the model training system 110 and the model application system 120 may be any system with computing power, such as various computing devices/systems, terminal devices, servers, and the like. Terminal equipment can be any type of mobile terminal, fixed terminal or portable terminal, comprising mobile phone, desktop computer, laptop computer, netbook computer, tablet computer, media computer, multimedia tablet, or any combination of the foregoing, comprising accessories and peripherals of these equipment or any combination thereof. Servers comprise but are not limited to mainframe, edge computing nodes, computing devices in cloud environment, etc.

It is to be understood that the components and arrangements in the environment shown in FIG. 1 are only examples, and a computing system suitable for implementing the example implementations described in the present disclosure may comprise one or more different components, other components, and/or different arrangements. For example, although shown as separate, the model training system 110 and the model application system 120 may be integrated in the same system or device. The implementation of this disclosure is not limited in this respect.

It is to be understood that the structure and function of each element in the environment 100 are described for illustrative purposes only, without implying any limitation on the scope of the present disclosure. In addition, although the hierarchy is shown in the form of a tree in FIGS. 1, 2A and 2B, this is only example and is not intended to limit the scope of the present disclosure. In the implementation of the present disclosure, the hierarchy may be represented in any suitable manner.

### Working Principle and Sample Architecture

As briefly mentioned above, it is desired to understand the hierarchical relationship of image elements. Organized images such as UI images usually have metadata that describes the hierarchical relationships of elements. For example, Web pages usually have a Document Object Model (DOM) as metadata, while mobile APP interfaces usually have a View Hierarchy (VH) as metadata. However, this metadata is not necessarily available. On the other hand, metadata can have different types and styles due to different operating systems (e.g., Android, iOS) and programming languages. This also makes it difficult to extract hierarchy. Further, unlike an organized image, a natural image does not have such metadata to describe hierarchical relationships. In view of this, it is necessary to provide a general solution for extracting hierarchy.

Some conventional image processing solutions cannot be used as such universal solutions. For example, in a screen resolution solution, only leaf nodes are detected and the relationship between leaf nodes is determined, but the relationship between higher level elements cannot be obtained. In an image parsing solution, semantic segmentation is implemented by assigning semantic categories to pixels in the image. In a scenario diagram generation solution, only the pairing relationship between elements is considered, and the hierarchical relationship is not considered. In the object detection solution, additional post-processing is required to organize the detected elements into a hierarchy.

The example implementations of the present disclosure propose a solution for parsing the hierarchical relationship of elements in an image. According to various implementations of the present disclosure, the input image is decomposed recursively up to atomic elements or up to elements of a predetermined level or up to elements of a predetermined granularity. That is, for the detected element, the next level element is detected in the element, thereby generating a hierarchy for the input image. Such hierarchy indicates the relationship between the elements in the input image. The second element in the first element is determined based on a feature(s) of the input image and the known first element in the input image (for example, a detected element or the entire input image). Based on the features of the input image and the second element, the third element at the next level is detected in the second element. Accordingly, the hierarchy is determined based on the determination of the second element and the detection result of the third element.

In implementations of the present disclosure, elements of the next level are recursively detected from the determined elements. In this way, the hierarchy of the elements in the image can be generated without post-processing. In addition, in implementations of the present disclosure, the hierarchy can be obtained by taking an image as an input without additional data. Therefore, implementations of the present disclosure provide a general solution for extracting hierarchies, which can be used to parse various types of images.

Some example implementations of the present disclosure will be described in more detail below with reference to the accompanying drawings.

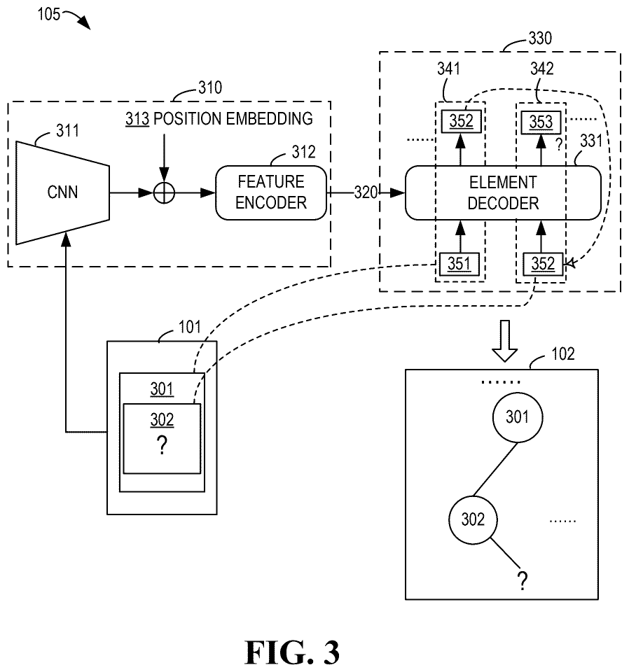

FIG. 3 shows an example architecture of an image parsing model 105 implemented in accordance with some of the present disclosure. In general, the image parsing model 105 comprises a feature extraction module 310 and an element detection module 330. The feature extraction module 310 is used to extract the feature 320 of the input image 101.

In the example of FIG. 3, the feature extraction module 310 comprises a convolutional neural network (CNN) 311. CNN 311 may be implemented in any suitable network structure (e.g., residual network). The CNN 311 is used to transform the input image 101 into the feature space. The feature map generated by CNN 311 is input to the feature encoder 312 in combination with the position embedding 313. The position embedding 313 indicates the position of each pixel block in the input image 101 in the input image 101.

The feature encoder 312 generates a feature 320 of the input image 101 based on the position embedding 313 and the feature map. Each feature vector in the feature 320 is related to the position of the represented pixel block in the input image 101. For example, the feature 320 may comprise a sequence of feature vectors, each of which represents a pixel block, and the position of the feature vector in the sequence is related to the position of the represented pixel block in the input image 101. In some implementations, the feature encoder 312 may be implemented based on the attention mechanism. For example, the feature encoder 312 may be implemented with a transformer encoder.

It is to be understood that the feature extraction module 310 shown in FIG. 3 is only illustrative and is not intended to limit the scope of the present disclosure. In the implementation of the present disclosure, any suitable number of networks and networks of any structure may be used to generate features of the input image 101.

The generated feature 320 is input to the element detection module 330. The element detection module 330 recursively detects elements of the next level in the image elements starting from the entire input image 101 based on the feature 320. In the element detection module 330, the task of parsing the hierarchical relationship of image elements is divided into a plurality of subtasks. These subtasks can be executed recursively. Each subtask attempts to detect elements at the next level among known elements (for example, the entire input image 101 or detected elements). In other words, each subtask attempts to decompose known elements. In this paper, detecting elements at the next level among elements at a certain level is called decomposing elements at that level. Determining the elements of the next level (comprising location or category) is called decoding the elements of the next level.

In each subtask, the element decoder 331 detects elements of the next level among the elements to be decomposed based on the feature 320 and the elements to be decomposed. For example, element decoder 330 may generate predicted tokens based on feature 320 and tokens of elements to be decomposed. The token of the image element can represent the image element in any suitable way. In some implementations, a token of an image element may comprise one or more position tokens that describe the position of the image element in the input image 101. For example, these position tokens may comprise the coordinates of the detection frame of the image element in the input image 101. Where the detection box is a rectangle, the position token can comprise the coordinates of two vertices of the rectangle. Additionally, the token of an image element may also comprise a category token representing an element category.

The element decoder 331 can be implemented in any suitable network structure. For example, when the feature encoder 312 is implemented with the Transformer encoder, the element decoder 331 can be implemented with the Transformer decoder.

FIG. 3 shows subtasks 341 and 342. The subtask 341 is used to decompose the known element 301 (also referred to as “first element”). In some implementations, the known element 301 may be the input image 101, the root node of the hierarchy 102. In some implementations, the known element 301 may be a detected element in the input image 101, such as an element detected by a subtask before the subtask 341.

The token 351 of the element 301 is input to the element decoder 331. The token 351 may include, for example, a position token of the element 301 and an optional category token. The element decoder 331 generates the token 352 based on the feature 320 and the token 351. In the example of FIG. 3, the token 352 represents a part of the element 301, for example, the image area described by the token 352 is within the detection frame of the element 301. Accordingly, the element detection module 330 determines that the element 302 represented by the token 352 (also referred to as “second element”) in the element 301 is detected. In the hierarchy 102, element 302 is added as a child node of element 301.

Upon detecting element 302, subtask 341 can continue to detect other elements in element 301 until element decoder 331 generates a predetermined token indicating the end of the subtask, which is also called the end token. Specifically, the token 351 of the element 301 and the token 352 of the element 302 can be input to the element decoder 331. The element decoder 331 generates another token based on the feature 320, token 351, and token 352. If the token describes a part of the element 301 and the part is different from the element 302, it can be determined that another element is detected as a child node of the element 301. If the element decoder 331 generates an end token, the element detection module 330 may end the subtask 341.

Since element 302 is detected in subtask 341, the element detection module 330 executes subtask 342 for element 302. Subtask 342 is used to detect the next level elements in element 302. The element detection module 330 determines the hierarchy 102 based on the detection results of the subtask 342. Specifically, based on the detection result, the element detection module 330 determines whether to add a child node of the element 302 in the hierarchy 102.

In subtask 342, the token 352 of element 302 is input to element decoder 331. Similar to the token 351, the token 352 may comprise a location token of element 302 and an optional category token. The element decoder 331 generates a token 353 based on the feature 320 and the token 352. If token 353 is an end token, it means that element 302 is not decomposable. Accordingly, element detection module 330 ends subtask 342 and determines element 302 as a leaf node in hierarchy 102.

If the token 353 represents a part of the element 302, for example, the image area described by the token 353 is within the detection frame of the element 302, the element detection module 330 can determine that the next level element represented by the token 353 is detected, which is also referred to “third element”. Accordingly, the element detection module 330 can add a third element in the hierarchy 102 as a child node of the element 302. In this case, subtask 342 may continue to detect other elements in element 302 until element decoder 331 generates an end token.

Element detection module 330 may continue to perform subtasks for detected elements. In some implementations, the element detection module 330 may cease the decomposition of the input image 101 until the next level of elements cannot be detected in each detected element. Alternatively, in some implementations, the element detection module 330 may cease the decomposition of the input image 101 in response to the detection of elements of a predetermined granularity or a predetermined level.

The subtasks 341 and 342 are described above with reference to FIG. 3, but this is only illustrative and is not intended to limit the scope of the present disclosure. For example, if another element included in element 301 is detected before element 302 is detected, element 302 is detected based on that element, feature 320, and element 301.

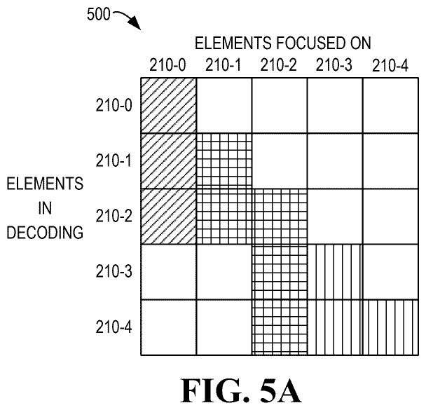

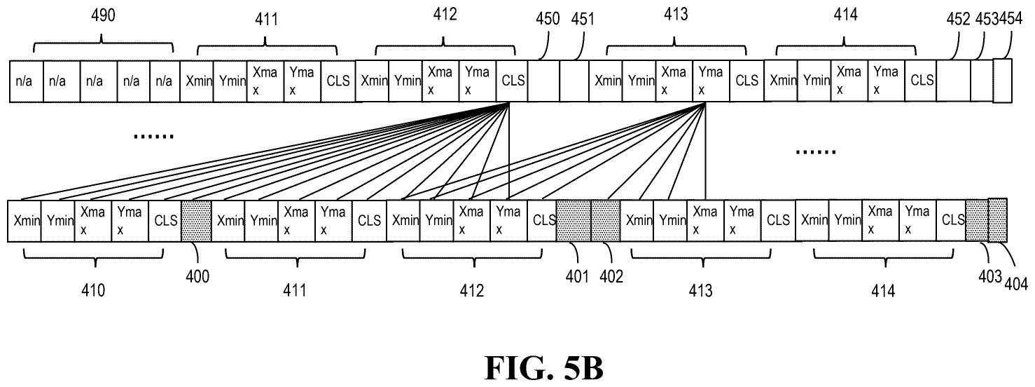

Furthermore, although the tokens 351, 352 and 353 are shown as one box in FIG. 3, this is only by way of example. A token of an image element may comprise a plurality of sub-tokens, such as a position token and a category token. In some implementations, the element decoder 331 may implement autoregressive decoding to sequentially predict each sub token in the token. For example, multiple location tokens and category tokens are predicted in turn. Such an example will be described below with reference to FIG. 5B.

As described with reference to FIG. 3, the task of parsing the hierarchical relationship of image elements is divided into recursive subtask sequences. In each subtask, the element as its child node is predicted for the known image element. In this way, not only each element in the input image is detected, but also the hierarchical relationship of these detected elements is determined without additional processing or other inputs.

### Example Process of Hierarchical Relationship Parsing

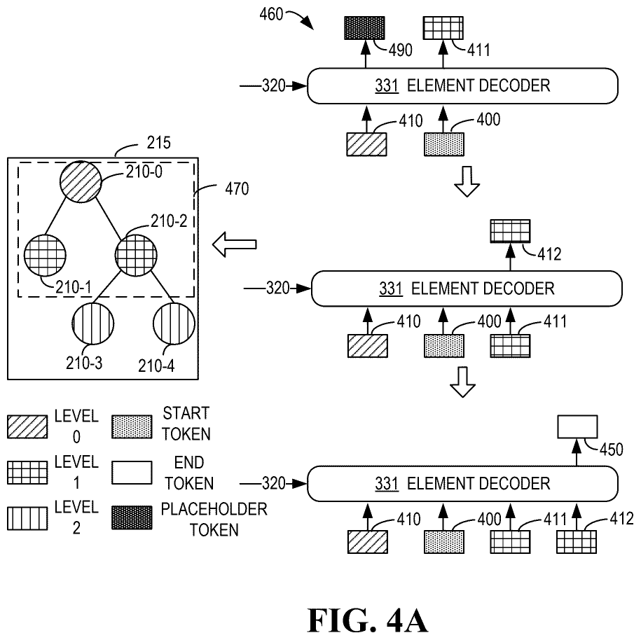

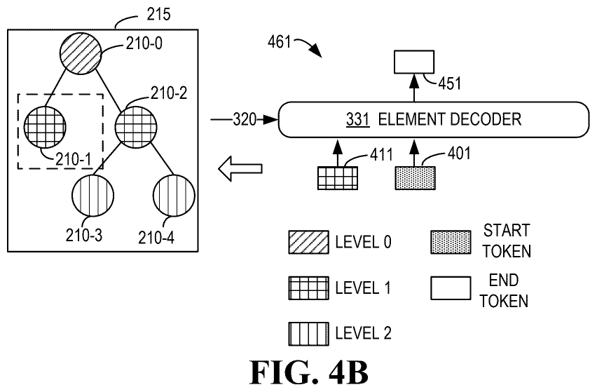

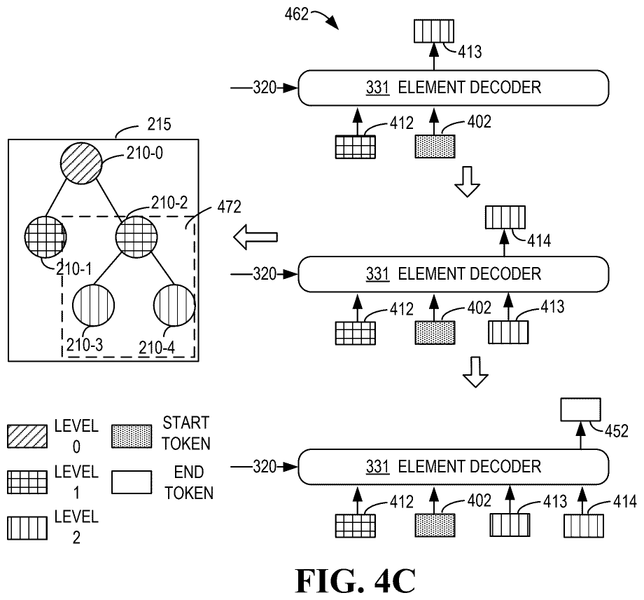

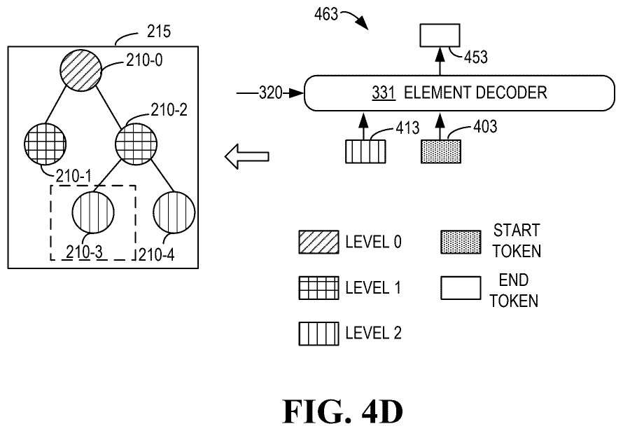

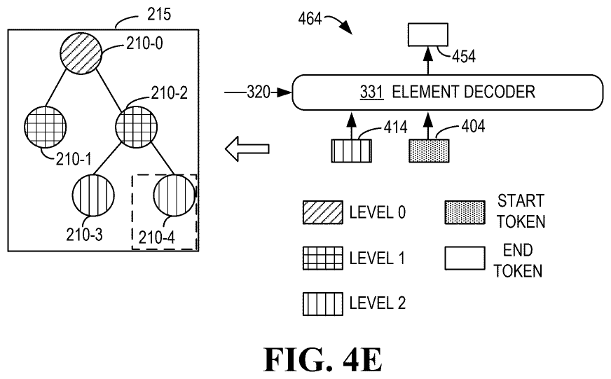

An example architecture of hierarchy analysis is described above with reference to FIG. 3. Taking the input image 201 shown in FIG. 2A as an example, the following describes an example process of hierarchical relationship analysis. FIGS. 4A to 4E show schematics of each subtask of recursively determining the hierarchy 215 for the input image 201 according to some implementations of the present disclosure.

FIG. 4A shows the subtask 460 of decomposing the element 210-0 (which is the input image 201) as the root node. In subtask 460, element decoder 331 generates a placeholder token 490 based on token 410 of element 210-0. Next, the token 410 and the start token 400 are input to the element decoder 331, and the start token 400 indicates to start detecting the element as its child node in the element 210-0. Accordingly, element decoder 331 generates a token 411 representing element 210-1 (which is a subscription option) based on feature 320, token 410, and start token 400. Thus, element 210-1 is added to level 1 of hierarchy 215 as a child node of element 210-0. Decoding of element 210-1 is based on element 210-0 as its parent node.

Subtask 460 continues to detect elements in level 1 included in element 210-0. The token 411 of the previously generated element 210-1 is fed to the element decoder 331 as input. The element decoder 331 generates a token 412 of the element 210-2 (which is the main part) based on the feature 320, token 410, start token 400, and token 411. Thus, element 210-2 is added to level 1 of hierarchy 215 as a child node of element 210-0. The decoding of element 210-2 is based on element 210-0 as its parent node and element 210-1 as its elder sibling node.

Subtask 460 continues to detect elements in level 1 included in element 210-0. The token 412 of the previously generated element 210-2 is fed to the element decoder 331 as an input. The element decoder 331 generates an end token 450 based on the feature 320, token 410, start token 400, token 411, and token 412. The end token 450 indicates the completion of the decomposition of element 210-0. Therefore, subtask 460 ends. As shown in FIG. 4A, through subtask 460, sub structure 470 in hierarchy 215 for input image 201 can be determined, such as sub tree.

Since element 210-1 is detected in subtask 460, element detection module 330 executes subtask 461 for decomposing element 210-1. As shown in FIG. 4B, the token 411 and the start token 401 of the element 210-1 are input to the element decoder 331, and the start token 401 indicates that the element as its child node is detected in the element 210-1. Accordingly, the element decoder 331 generates an end token 451 based on the feature 320, token 411, and start token 401. The generation of the end token 451 means that element 210-1 is not decomposable, for example, element 210-1 is atomic. Therefore, subtask 461 ends. As shown in FIG. 4B, element 210-1 can be determined as a leaf node in hierarchy 215 through subtask 461.

Since element 210-2 is detected in subtask 460, the element detection module 330 executes subtask 462 for decomposing element 210-2. As shown in FIG. 4C, the token 412 and start token 402 of the element 210-2 are input to the element decoder 331, and the start token 402 indicates that the element as its child node is detected in the element 210-2. Accordingly, the element decoder 331 generates a token 413 representing the element 210-3, which is an icon in the main body, based on the feature 320, the token 412, and the start token 402. Thus, element 210-3 is added as a child node of element 210-2 in level 2 of hierarchy 215. Decoding of the element 210-3 is based on the element 210-2 as its parent node.

Subtask 462 continues to detect elements in level 2 included in element 210-2. The token 413 of the previously generated element 210-3 is fed to the element decoder 331 as an input. The element decoder 331 generates a token 414 of the element 210-4, which is the text in the main body, based on the feature 320, the token 412, the start token 402, and the token 413. Thus, element 210-4 is added as a child node of element 210-2 in level 2 of hierarchy 215. The decoding of the element 210-4 is based on the element 210-2 as its parent node and the element 210-3 as its brother node.

Subtask 462 continues to detect elements in level 2 included in element 210-2. The token 414 of the previously generated element 210-4 is fed to the element decoder 331 as input. The element decoder 331 generates an end token 452 based on the feature 320, token 412, start token 402, token 413, and token 414. The end token 452 indicates that the decomposition of the element 210-2 has been completed. Therefore, subtask 462 ends. As shown in FIG. 4C, sub structure 472 in hierarchy 215 can be determined by subtask 462.

Since element 210-3 is detected in subtask 462, element detection module 330 executes subtask 463 for decomposing element 210-3. As shown in FIG. 4D, the token 413 and start token 403 of the element 210-3 are input to the element decoder 331, and the start token 403 indicates that the element as its child node is detected in the element 210-3. Accordingly, the element decoder 331 generates an end token 453 based on the feature 320, token 413, and start token 403. The generation of the end token 453 means that the element 210-3 is not decomposable, for example, the element 210-3 is atomic. Therefore, subtask 463 ends. As shown in FIG. 4D, element 210-3 can be determined as a leaf node in hierarchy 215 through subtask 463.

Since element 210-4 is detected in subtask 462, element detection module 330 executes subtask 464 for decomposing element 210-4. As shown in FIG. 4E, the token 414 and start token 404 of element 210-4 are input to element decoder 331, and the start token 404 indicates that the element as its child node is detected in element 210-4. Accordingly, the element decoder 331 generates an end token 454 based on the feature 320, the token 414, and the start token 404. The generation of the end token 454 means that element 210-4 is not decomposable, for example, element 210-4 is atomic. Therefore, subtask 464 ends. As shown in FIG. 4E, element 210-4 can be determined as a leaf node in hierarchy 215 through subtask 464.

As described with reference to FIGS. 4A to 4E, the task of recursively parsing the hierarchical relationship of image elements for the input image can be divided into several subtasks. In some implementations, some of these subtasks can be executed in parallel or partially in parallel. The subtasks of decomposing sibling nodes in the same layer can be executed in parallel. For example, subtasks 461 and 462 can be executed in parallel, and subtasks 463 and 464 can be executed in parallel. The subtasks of the decomposed child node can be partially executed in parallel with the subtasks of the decomposed parent node. For example, after the subtask 460 is not finished but the element 210-1 is detected, the subtask 461 can be executed in parallel with the subtask 460. By executing at least some subtasks in parallel, the prediction speed of hierarchy can be improved.

As described with reference to FIGS. 4B to 4E, the decoding of low-level elements (for example, elements in level 2) is not based on the entire input image 201, but on one or more known elements related to that element. FIG. 5A shows a schematic diagram of the attention mask 500 among different elements according to some implementations of the present disclosure. As shown in FIG. 5A, the decoding of element 210-1 focuses on (i.e., based on) element 210-0 as its parent node. The decoding of element 210-2 focuses on element 210-0 as its parent node and element 210-1 as its brother node. Decoding of element 210-3 focuses on element 210-2 as its parent node. The decoding of element 210-4 focuses on element 210-2 as its parent node and element 210-3 as its elder sibling node.

FIG. 5B shows an example of a dependency between an output token and an input token in the parsing process according to some implementations of the present disclosure. In FIG. 5B, the tokens 410, 411, 412, 413, 414 of the image elements respectively comprise position tokens Xmin, Ymin, Xmax, Ymax and category tokens CLS. The position tokens Xmin, Ymin, Xmax and Ymax can be the coordinates of the detection box of image elements in the input image. For the element 210-0, the position tokens Xmin and Ymin in the token 410 can be 0, the position token Xmax can be the width of the input image 101, and the position token Ymax can be the height of the input image 101.

The element decoder 331 may autoregressively decode an image element, that is, autoregressively determine a position token and a category token among the tokens of the image element. As an example, the decoding of element 210-2 focuses on element 210-0 as its parent node and element 210-1 as its brother node. Therefore, the generation of the category token CLS in token 412 of element 210-2 is based on the following items: token 410 of element 210-0 (comprising location token and category token), start token 400, token 411 of element 210-1 (comprising location token and category token), and the decoded location tokens Xmin, Ymin, Xmax, and Ymax in token 412.

As another example, the decoding of the element 210-3 focuses on the element 210-2 as its parent node. Therefore, the generation of position token Ymax in token 413 of element 210-3 is based on the following items: token 412 of element 210-2 (comprising position token and category token), start token 402, and decoded position tokens Xmin, Ymin, Xmax in token 413.

In this implementation, the context of the detected element is limited to its associated parent node and brother node. This eliminates interference from other elements that are not related to the detected element. In FIG. 5B, the connection between the output token and the input token represents the dependency, but the connection shown is only an example. According to the above description with reference to FIGS. 4A to 4E, it can be understood that the dependency relationship between the output token and the input token is not shown.

It is to be understood that the process of hierarchical relationship analysis described with reference to FIGS. 4A to 4E, 5A and 5B is only example, and is not intended to limit the scope of the present disclosure. In the implementation of the present disclosure, the hierarchy can have any number of levels and nodes. The implementation of this disclosure is not limited in this respect. In addition, although atomic elements are used as leaf nodes in FIGS. 4A to 4E, this is only example. In some implementations, the decomposition of the input image 101 may be ended in response to the detection of elements of a predetermined granularity or a predetermined level.

### Evaluation of Hierarchy

In implementations of the present disclosure, a hierarchy indicating the hierarchical relationship of elements in an image is generated. This is different from the output of traditional image detection tasks. In view of this, in some implementations, metrics for hierarchies can be defined to accurately evaluate the generated hierarchies.

For this purpose, a reference hierarchy indicating the relationship between the elements in the input image 101 can be acquired. Nodes in the reference hierarchy correspond to elements in the input image 101. The reference hierarchy can be considered as the true value of the predicted hierarchy 102. Depending on the type of the input image 101, the reference hierarchy may be obtained in different ways. For example, if the input image 101 is an organized image with metadata (such as a UI image), the reference hierarchy can be determined based on metadata. If the input image 101 is a natural image without metadata, the reference hierarchy can be obtained by manual annotation, or the reference hierarchy can be determined by using the developed object detection algorithm and combining post-processing.

In order to compare the reference hierarchy with the forecast hierarchy 102, it is necessary to match the nodes in the reference hierarchy (also called reference nodes) with the forecast nodes in the hierarchy 102. As an example, the Hungarian algorithm can be used to match the reference node with the prediction node. The similarity between a pair of reference nodes and prediction nodes can be expressed by the overlap over Union (IoU) between the two nodes. IoU is the ratio of the intersection of the range of the element represented by the reference node in the input image 101 and the range of the element represented by the prediction node in the input image 101 (for example, the detection frame) to the union of these two ranges. If the IoU of a pair of reference nodes and prediction nodes is greater than the threshold, it can be considered that the pair of nodes are matched, so they are assigned the same node ID. If the IoU of a pair of reference nodes and prediction nodes is less than the threshold, it can be considered that the pair of nodes do not match, so they are assigned different node IDs. Thus, a comparable reference hierarchy and a predicted hierarchy 102 can be obtained.

Further, a set of node editing operations are determined to convert the predicted hierarchy 102 into a reference hierarchy or convert the reference hierarchy into a hierarchy 102. Node editing operations may include, but are not limited to, node insertion, node removal, and node identification changes. This set of node editing operations can be a sequence of node editing operations with the lowest cost required for hierarchical transformation. The hierarchy 102 may be evaluated based on the determined set of node editing operations. For example, the value of the evaluation measure may be related to the number of editing operations of the group of nodes. The larger the number, the greater the difference between the predicted hierarchy 102 and the reference hierarchy.

The evaluation metric described above can be regarded as the tree edit distance (H-TED) based on Hungarian algorithm. This evaluation measure not only considers the structure information between different nodes, but also considers the location information of each node. Therefore, this evaluation metric is more suitable for the task of parsing the hierarchical relationship of image elements.

### Training of Image Parsing Model

In the training of the image parsing model 105, for the training image 114, the input sequence and the target sequence of the element decoder 331 can be generated based on the corresponding hierarchy 112. Specifically, for the subtask of decomposing each element, an input token sequence can be generated as the input of the element decoder 331 based on the tokens of the elements to be decomposed in the hierarchy 112 (for example, a token sequence consisting of a position token and a category token), a start token, and the like. The element decoder 331 generates a prediction token sequence based on an input token sequence. Accordingly, a target token sequence as a truth value can be generated based on at least one of the tokens or end tokens of the elements at the next level of the element to be decomposed. The image parsing model 105 is updated at least by minimizing the difference between the predicted token sequence and the target token sequence until it converges or a predetermined number of training rounds.

Position tokens may be represented by probability distributions on a plurality of predetermined coordinates in the training image 114, and category tokens may be represented by probability distributions on a plurality of predetermined categories. The loss function can be determined based on the difference between the probability distribution of the prediction token and the target token as the true value. The image parsing model 105 can be updated by minimizing the loss function until it converges or a predetermined number of training rounds.

In some implementations, a token that does not represent any element in the training image 114 may be added to the input token sequence of the element decoder 331. Such tokens can be regarded as noise tokens. Noise tokens can be randomly attached to subtasks. For example, after the element decoder 331 generates an end token, a noise token may be added to the input sequence. Since the noise token does not represent any element in the training image 114, the noise token does not have a position token as a true value but instead has a category token as a true value (i.e., a noise category). In training, the image parsing model 105 generates predictive category tokens based on noise tokens. The loss function may be determined based on the difference between the probability distribution of the predicted category token and the noise category as the true value, thereby updating the image parsing model 150. Using noise tokens to train the image analytic model 105 can improve the robustness of the model to noise and repeated prediction results.

Example aspects of training of the image parsing model 105 are described above. In the implementation of the present disclosure, the image parsing model 105 may be trained in any suitable manner to achieve the hierarchical relationship analysis described herein.

### Example Flow

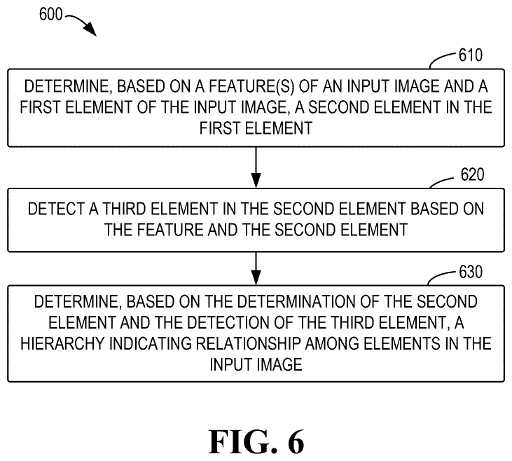

FIG. 6 shows a flowchart of a process 600 for parsing hierarchical relationships of image elements implemented in accordance with some of the present disclosure. Process 600 may be implemented at model application system 120 of FIG. 1.

At block 610, the model application system 120 determines a second element in the first element based on a feature(s) of the input image 101 and a first element in the input image 101. The first element may be any known element in the input image 101, such as the entire input image 101 or the detected element in the input image 101. A second element was detected in the first element.

At block 620, the model application system 120 detects a third element in the second element based on the feature and the second element. The first, second and third elements are corresponding to respective regions in the input image 101. For example, subtasks for decomposing the second element are executed to try to detect the elements of the next level included in the second element.

In some implementations, in order to detect the third element, the model application system 120 can obtain the output of the element decoder based on the feature and the position of the second element in the input image 101. If it is determined that the output represents a part of the second element, the model application system 120 may determine that the third element is detected. In some implementations, if it is determined that the output represents the end of element detection, the model application system 120 may determine that no third element is detected.

At block 630, the model application system 120 determines a hierarchy 102 indicating the relationship between elements in the input image 101 based on the determination of the second element and the detection result of the third element. Since the second element is detected in the first element, the model application system 120 adds the second element in the hierarchy 102 as a child node of the first element.

In some implementations, if the third element is detected, the model application system 120 adds the third element in the hierarchy 102 as a child node of the second element. In some implementations, if the third element is not detected, the second element is determined as a leaf node in the hierarchy 102.

In some implementations, the model application system 120 can also detect a fourth element in the second element based on features, the second element and the third element. The fourth element corresponds to an area in the input image 101. If the fourth element is detected, the model application system 120 adds the fourth element in the hierarchy 102 as a child node of the second element.

The nodes in the hierarchy 102 are corresponding to the elements detected in the input image 101. In some implementations, the model application system 120 can also obtain a reference hierarchy 102 indicating the relationship between elements in the input image 101, and the nodes in the reference hierarchy 102 correspond to the elements in the input image 101. The model application system 120 may also determine a set of node editing operations to convert the generated hierarchy 102 into a reference hierarchy 102. The model application system 120 can also determine the evaluation of the generated hierarchy 102 based on a set of node editing operations.

In some implementations, the input image 101 comprises a user interface image, and the element comprises a user interface element.

### Sample Device

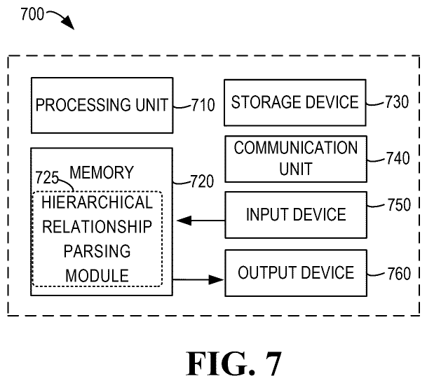

FIG. 7 shows a schematic block diagram of an electronic device capable of implementing various implementations of the present disclosure. It is to be understood that the electronic device 700 shown in FIG. 7 is only example and should not constitute any limitation on the function and scope of the implementation described in the present disclosure.

As shown in FIG. 7, the electronic device 700 comprises an electronic device 700 in the form of a general-purpose computing device. The components of electronic device 700 may comprise, but are not limited to, one or more processors or processing units 710, a memory 720, a storage device 730, one or more communication units 740, one or more input devices 750, and one or more output devices 760.

In some implementations, the electronic device 700 can be implemented as a computing device, computing system, server, mainframe, and other computing capable devices.

The processing unit 710 can be an actual or virtual processor and can perform various processes according to the programs stored in the memory 720. In a multiprocessor system, a plurality of processing units executes computer executable instructions in parallel to improve the parallel processing capability of electronic device 700. The processing unit 710 may comprise a central processing unit (CPU), a graphics processing unit (GPU), a microprocessor, a controller, and/or a microcontroller.

The electronic device 700 typically comprises a plurality of computer storage media. Such media may be any available media accessible to electronic device 700, comprising but not limited to volatile and non-volatile media, removable and non removable media. The memory 720 may comprise volatile memory (such as registers, cache, random access memory (RAM)), non-volatile memory (such as read-only memory (ROM), electrically erasable programmable read-only memory (EEPROM), flash memory), or some combination thereof. The storage device 730 may comprise removable or non-removable media, and may comprise computer-readable media such as memory, flash drives, disks, or any other media that can be used to store information and/or data and can be accessed within the electronic device 700.

The electronic device 700 may further comprise additional removable/non removable, volatile/non-volatile storage media. Although not shown in FIG. 7, a disk drive for reading or writing from a removable, nonvolatile disk and an optical disk drive for reading or writing from a removable, nonvolatile optical disk may be provided. In these cases, each drive may be connected to a bus (not shown) by one or more data medium interfaces.

The communication unit 740 realizes communication with another computing device through a communication medium. Additionally, the functions of the components of the electronic device 700 can be implemented in a single computing cluster or a plurality of computing machines that can communicate through a communication connection. Therefore, electronic device 700 can operate in a networked environment using a logical connection to one or more other servers, personal computers (PCs), or another general network node.

The input device 750 may be one or more various input devices, such as a mouse, a keyboard, a data import device, and the like. The output device 760 may be one or more output devices, such as a display, a data export device, and the like. The electronic device 700 can also communicate with one or more external devices (not shown) through the communication unit 740 as required, such as storage devices, display devices, etc., with one or more devices that enable users to interact with the electronic device 700, or with any device (such as network cards, modems, etc.) that enables the electronic device 700 to communicate with one or more other computing devices. Such communication may be performed via an input/output (I/O) interface (not shown).

In some implementations, in addition to being integrated on a single device, some or all of the components of the electronic device 700 may also be set in the form of a cloud computing architecture. In the cloud computing architecture, these components can be remotely arranged and can work together to implement the functions described in the present disclosure. In some implementations, cloud computing provides computing, software, data access and storage services, which do not require the end user to know the physical location or configuration of the system or hardware providing these services. In various implementations, cloud computing uses appropriate protocols to provide services over a wide area network, such as the internet. For example, cloud computing providers provide applications over a wide area network, and they can be accessed through a web browser or any other computing component. The software or component of cloud computing architecture and corresponding data can be stored on the server at a remote location. Computing resources in a cloud computing environment can be combined at remote data center locations or they can be dispersed. Cloud computing infrastructure can provide services through shared data centers, even if they represent a single point of access for users. Therefore, the components and functions described herein can be provided from a service provider at a remote location using a cloud computing architecture. Alternatively, they may be provided from a conventional server, or they may be installed directly or otherwise on a client device.

The electronic device 700 may be used to implement hierarchical relationship parsing in various implementations of the present disclosure. The memory 720 may comprise one or more modules having one or more program instructions, which may be accessed and run by the processing unit 760 to implement various implemented functions described herein. For example, the memory 720 may comprise a hierarchical relationship parsing module 725 for determining the structure of a table in an image. As shown in FIG. 7, the electronic device 700 can acquire the image 101 through the input device 750, and can provide the recognition result 102 through the output device 760. In some implementations, the electronic device 700 may also receive input from other devices (not shown) via the communication unit 740.

### Example Implementations

Some example implementations of this disclosure are listed below.

In one aspect, the present disclosure provides a computer implementation method. The method comprises: determining, based on a feature of an input image and a first element of the input image, a second element in the first element; detecting a third element in the second element based on the feature and the second element, the first second element and third elements corresponding to respective regions in the input image; and determining, based on the determination of the second element and the detection of the third element, a hierarchy indicating relationship among elements in the input image.

In some example implementations, determining the hierarchy comprises: adding the second element to the hierarchy as a child node of the first element; and if the third element is detected, adding the third element to the hierarchy as a child node of the second element.

In some example implementations, the method also comprises: detecting a fourth element in the second element based on the feature, the second element and the third element, the fourth element corresponding to a region in the input image; and if the fourth element is detected, adding the fourth element to the hierarchy as a child node of the second element.

In some example implementations, detecting the third element comprises: obtaining an output of an element decoder based on the feature and a position of the second element in the input image; and if it is determined that the output represents a part of the second element, determining that the third element is detected.

In some example implementations, the method also comprises: if it is determined that the output represents an end of element detection, determining that the third element is not detected.

In some example implementations, the nodes in the hierarchy correspond to the elements detected in the input image, and the method also comprises: obtaining a reference hierarchy indicating relationship between elements in the input image, nodes in the reference hierarchy corresponding to elements in the input image; determining a set of node editing operations that transform the generated hierarchy into the reference hierarchy; and determining an evaluation for the generated hierarchy based on the set of node editing operations.

In some example implementations, the input image comprises an image of a user interface image, and the element comprises a user interface element.

On the other hand, the present disclosure provides an electronic device. The electronic device comprises a processor; and a memory coupled to the processor and comprising instructions stored thereon, the instructions when executed by the processor causing the electronic device to perform acts comprising: determining, based on a feature of an input image and a first element of the input image, a second element in the first element; detecting a third element in the second element based on the feature and the second element, the first second element and third elements corresponding to respective regions in the input image; and determining, based on the determination of the second element and the detection of the third element, a hierarchy indicating relationship among elements in the input image.

In some example implementations, determining the hierarchy comprises: adding the second element to the hierarchy as a child node of the first element; and if the third element is detected, adding the third element to the hierarchy as a child node of the second element.

In some example implementations, the acts further comprise: detecting a fourth element in the second element based on the feature, the second element and the third element, the fourth element corresponding to a region in the input image; and if the fourth element is detected, adding the fourth element to the hierarchy as a child node of the second element.

In some example implementations, detecting the third element comprises: obtaining an output of an element decoder based on the feature and a position of the second element in the input image; and if it is determined that the output represents a part of the second element, determining that the third element is detected.

In some example implementations, the acts further comprise: if it is determined that the output represents an end of element detection, determining that the third element is not detected.

In some example implementations, the nodes in the hierarchy correspond to the elements detected in the input image, and the acts also comprise: obtaining a reference hierarchy indicating relationship between elements in the input image, nodes in the reference hierarchy corresponding to elements in the input image; determining a set of node editing operations that transform the generated hierarchy into the reference hierarchy; and determining an evaluation for the generated hierarchy based on the set of node editing operations.

In some example implementations, the input image comprises a user interface image, and the element comprises a user interface element.

On the other hand, the present disclosure provides a computer program product. The computer program product is tangibly stored in a computer storage medium and comprises computer executable instructions. When the computer executable instructions are executed by the device, the device performs the acts comprising: determining, based on a feature of an input image and a first element of the input image, a second element in the first element; detecting a third element in the second element based on the feature and the second element, the first second element and third elements corresponding to respective regions in the input image; and determining, based on the determination of the second element and the detection of the third element, a hierarchy indicating relationship among elements in the input image.

In some example implementations, determining the hierarchy comprises: adding the second element to the hierarchy as a child node of the first element; and if the third element is detected, adding the third element to the hierarchy as a child node of the second element.

In some example implementations, the acts further comprise: detecting a fourth element in the second element based on the feature, the second element and the third element, the fourth element corresponding to a region in the input image; and if the fourth element is detected, adding the fourth element to the hierarchy as a child node of the second element.

In some example implementations, detecting the third element comprises: obtaining an output of an element decoder based on the feature and a position of the second element in the input image; and if it is determined that the output represents a part of the second element, determining that the third element is detected.

In some example implementations, the acts further comprise: if it is determined that the output represents an end of element detection, determining that the third element is not detected.

In some example implementations, the nodes in the hierarchy correspond to the elements detected in the input image, and the acts further comprises: obtaining a reference hierarchy indicating relationship between elements in the input image, nodes in the reference hierarchy corresponding to elements in the input image; determining a set of node editing operations that transform the generated hierarchy into the reference hierarchy; and determining an evaluation for the generated hierarchy based on the set of node editing operations.

In some example implementations, the input image comprises a user interface image, and the element comprises a user interface element.

In another aspect, the present disclosure provides a computer-readable medium on which computer executable instructions are stored, which, when executed by a device, cause the device to execute one or more example implementations of the methods in the above aspects.

The functions described above herein may be performed at least partially by one or more hardware logical units. For example and without limitation, example types of hardware logic components that can be used include: field programmable gate array (FPGA), application specific integrated circuit (ASIC), application specific standard product (ASSP), system on chip (SOC), load programmable logic device (CPLD), and so on.

The program code for implementing the methods of the present disclosure may be written in any combination of one or more programming languages. These program codes can be provided to a processor or controller of a general-purpose computer, a special purpose computer or other programmable data processing device, so that when the program code is executed by a processor or controller, the functions/operations specified in the flow chart and/or block diagram are implemented. The program code can be executed completely on the machine, partially on the machine, partially on the machine and partially on the remote machine or completely on the remote machine or server as a separate software package.

In the context of the present disclosure, a machine-readable medium may be a tangible medium, which may contain or store programs for use by or in combination with an instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, devices, or devices, or any suitable combination of the foregoing. A more specific example of a machine-readable storage medium would comprise an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

In addition, although the operations are described in a particular order, it is to be understood that such operations are required to be performed in a particular order shown or in a sequential order, or that all illustrated operations should be performed to obtain a desired result. Under certain circumstances, multitasking and parallel processing may be beneficial. Similarly, although the above discussion contains a number of specific implementation details, these should not be interpreted as limiting the scope of the disclosure. Some characteristics described in the context of a separate implementation can also be implemented in a single implementation in combination. Conversely, various features described in the context of a single implementation can also be implemented in multiple implementations individually or in any suitable sub combination.

Although the subject matter has been described in terms specific to the structural features and/or method logic actions, it is to be understood that the subject matter defined in the appended claims is not necessarily limited to the specific features or actions described above. On the contrary, the specific features and actions described above are only examples of realizing the claims.

1. A computer-implementation method, comprising:
determining, based on a feature of an input image and a first element of the input image, a second element in the first element;
detecting a third element in the second element based on the feature and the second element, the first second element and third elements corresponding to respective regions in the input image; and
determining, based on the determination of the second element and the detection of the third element, a hierarchy indicating relationship among elements in the input image.

2. The method of claim 1, wherein determining the hierarchy comprises:
adding the second element to the hierarchy as a child node of the first element; and
if the third element is detected, adding the third element to the hierarchy as a child node of the second element.

3. The method of claim 2, further comprising:
detecting a fourth element in the second element based on the feature, the second element and the third element, the fourth element corresponding to a region in the input image; and
if the fourth element is detected, adding the fourth element to the hierarchy as a child node of the second element.

4. The method of claim 1, wherein detecting the third element comprises:
obtaining an output of an element decoder based on the feature and a position of the second element in the input image; and
if it is determined that the output represents a part of the second element, determining that the third element is detected.

5. The method of claim 4, further comprising:
if it is determined that the output represents an end of element detection, determining that the third element is not detected.

6. The method of claim 1, wherein nodes in the hierarchy are corresponding to elements detected in the input image, and the method further comprises:
obtaining a reference hierarchy indicating relationship between elements in the input image, nodes in the reference hierarchy corresponding to elements in the input image;
determining a set of node editing operations that transform the generated hierarchy into the reference hierarchy; and
determining an evaluation for the generated hierarchy based on the set of node editing operations.

7. The method of claim 1, wherein the input image comprises an image of a user interface, and the element comprises a user interface element.

8. An electronic device comprising:
a processing unit; and
a memory coupled to the processing unit and comprising instructions stored thereon, the instructions when executed by the processing unit causing the electronic device to perform acts comprising:
determining, based on a feature of an input image and a first element of the input image, a second element in the first element;
detecting a third element in the second element based on the feature and the second element, the first second element and third elements corresponding to respective regions in the input image; and
determining, based on the determination of the second element and the detection of the third element, a hierarchy indicating relationship among elements in the input image.

9. The device of claim 8, wherein determining the hierarchy comprises:
adding the second element to the hierarchy as a child node of the first element; and
if the third element is detected, adding the third element to the hierarchy as a child node of the second element.

10. The device of claim 9, wherein the acts further comprise:
detecting a fourth element in the second element based on the feature, the second element and the third element, the fourth element corresponding to a region in the input image; and
if the fourth element is detected, adding the fourth element to the hierarchy as a child node of the second element.

11. The device of claim 8, wherein detecting the third element comprises:
obtaining an output of an element decoder based on the feature and a position of the second element in the input image; and
if it is determined that the output represents a part of the second element, determining that the third element is detected.

12. The device of claim 11, wherein the acts further comprise:
if it is determined that the output represents an end of element detection, determining that the third element is not detected.

13. The device of claim 8, wherein nodes in the hierarchy are corresponding to elements detected in the input image, and the acts further comprises:
obtaining a reference hierarchy indicating relationship between elements in the input image, nodes in the reference hierarchy corresponding to elements in the input image;
determining a set of node editing operations that transform the generated hierarchy into the reference hierarchy; and
determining an evaluation for the generated hierarchy based on the set of node editing operations.

14. The device of claim 8, wherein the input image comprises an image of a user interface, and the element comprises a user interface element.

15. A computer program product comprising computer executable instructions that, when executed by a device, cause the device to perform acts comprising:
determining, based on a feature of an input image and a first element of the input image, a second element in the first element;
detecting a third element in the second element based on the feature and the second element, the first second element and third elements corresponding to respective regions in the input image; and
determining, based on the determination of the second element and the detection of the third element, a hierarchy indicating relationship among elements in the input image.

16. The computer program product of claim 15, wherein determining the hierarchy comprises:
adding the second element to the hierarchy as a child node of the first element; and
if the third element is detected, adding the third element to the hierarchy as a child node of the second element.

17. The computer program product of claim 16, wherein the acts further comprise:
detecting a fourth element in the second element based on the feature, the second element and the third element, the fourth element corresponding to a region in the input image; and
if the fourth element is detected, adding the fourth element to the hierarchy as a child node of the second element.

18. The computer program product of claim 15, wherein detecting the third element comprises:
obtaining an output of an element decoder based on the feature and a position of the second element in the input image; and
if it is determined that the output represents a part of the second element, determining that the third element is detected.

19. The computer program product of claim 18, wherein the acts further comprise:
if it is determined that the output represents an end of element detection, it is determined that the third element is not detected.

20. The computer program product of claim 15, wherein nodes in the hierarchy are corresponding to elements detected in the input image, and the acts further comprises:
obtaining a reference hierarchy indicating relationship between elements in the input image, nodes in the reference hierarchy corresponding to elements in the input image;
determining a set of node editing operations that transform the generated hierarchy into the reference hierarchy; and
determining an evaluation for the generated hierarchy based on the set of node editing operations.
